(19) United States
(12) Patent Application Publication
(10) Pub. No.: US 2006/0157563 A1
(43) Pub. Date: Jul. 20, 2006

(54) Smart card systems in connection with transportation services

(76) Inventor: David A. Marshall, Fort Lauderdale, FL (US)

Correspondence Address: Jonathan A. Bay;Attorney at Law, Suite 314, 333 Park Central East, Springfield, MO, 65806, US

(21) Appl. No.: 11/292,935

(22) Filed: Dec. 1, 2005

Related U.S. Application Data
(63) Continuation-in-part of application No. 11/156,261, filed on Jun. 17, 2005.
(60) Provisional application No. 60/580,603, filed on Jun. 17, 2004.

(51) Int. Cl. G06K 5/00

(52) U.S. Cl. 235/382

(57) ABSTRACT

A dual-interface (contact and contactless) “smart card” which supports (transportation-related) functions. The smart card acts as a user ID which tracks stored value, transit or taxicab fare, parking, car sharing or rental car membership/loyalty. The smart card tracks these functions for users as a means of saving money. The smart card can also be used to control access to a vehicle with multiple authorized users (either rental or fractional lease), manage automobile insurance information and driver-specific settings. These functions reduce an organizational need and help keeps users transportation records up to date.

### CROSS-REFERENCE TO RELATED APPLICATION(S)

This application is a continuation-in-part of U.S. patent application Ser. No. 11/156,261, filed Jun. 17, 2005, which claims the benefit of U.S. Provisional Application No. 60/580,603, filed Jun. 17, 2004, both of which are fully incorporated herein by this reference.

### BACKGROUND AND SUMMARY OF THE INVENTION

The invention relates to smart card systems deployed or utilized in connection with the provision of transportation services and the like.

More particularly, the field of the invention relates to innovative mobility solutions, such as shared-use vehicle memberships, in which the paradigm of an individual's car ownership is moved away from individual car ownership to share use with the members of the membership.

The state of the art of shared-use vehicle memberships is summarized by the technical report of Barth, M. and Susan S. Shaheen, “Shared-Use Vehicle Systems: Framework for Classifying Carsharing, Station Cars, and Combined Approaches,” Transportation Research Record 1791, pages 105-112 (Paper No. 02-3854© 2002), which technical report is incorporated fully herein by this reference to it.

Briefly, such shared-use vehicle memberships range from neighborhood Car-sharing business-models to classic Station Cars business-models, with multi-nodal shared-use vehicle business-models finding a fit somewhere in the mix.

The advantages of shared-use vehicle memberships include lower costs to drivers, lower pressure on municipalities or institutions and also businesses to increase number of parking spaces for drivers, as well as inducing drivers to forsake personally-driven vehicles in favor of mass transit.

Again, the foregoing three (3) advantages might be more fully stated as follows. That is, one advantage is that shared-use vehicle memberships tend to reduce the number of vehicles needed to meet a user community's overall travel demand. Vehicles spend less time idle and more time utilized, albeit by different users. Also, the user community communally shares transportation costs such a vehicle payments, insurance, maintenance. Two, since a vehicle is less likely to be idled (parked) for a whole day at the first driver's destination, and more likely to be driven off by a succeeding driver to his or her succeeding destination, this frees up parking spaces. Three, mass transit ridership is increased when users pick up or drop off a shared-use vehicle at a mass transit station because users are now more conscious of their trip-making and choices over modes of travel.

A number of additional features and objects will be apparent in connection with the following discussion of the preferred embodiments and examples

### DETAILED DESCRIPTION OF THE PREFERRED EMBODIMENTS

A smartcard system in accordance with the invention for transportation applications, predominantly though not exclusively, comprises the following preferred aspects. That is, such a system preferably involves the following parties, services of such, or parties:—
1. A central network (or system) authority,
2. Any suitable network communications medium,
3. A network of distributed nodes (pause will be taken shortly to can be examine the term “node”),
4. A network fleet of shared-use vehicles parked, picked up or dropped off at the distributed nodes,
5. Network telematic devices onboard each vehicle having active RFID readers (pause will be taken shortly to can be examine the phrase “RFID readers”),
6. A network of user or network smartcards having:—
   passive (preferably passive, perhaps semi-active or active) RFID transmission/reception circuitry,
   read/write memory, and
   a microprocessor for data retrieval, storage and, for executable data, execution thereon,
7. Non-network transit affiliates, with RFID readers, and,
8. Non-network loyalty affiliates (eg., merchants), with RFID readers.

Pause is now taken to consider the term “node.” The nodes in a network of shared-use vehicles in common usage can be variously referred to as:
lots (eg., parking lots),
stations,
depots,
ports,
terminals (eg., ends of a course),
stops (eg., intermediate points on a course)
hubs (eg., a course and a branch, or radiating courses, presumptively requiring transfers to hop from an infeed to a non-continuous outflow).

Not all nodes are equal, in fact they are likely quite distinct from one another. Hence there might be:
major nodes (full service, or large inventory),
minor nodes (restricted services or inventory),
neighborhoods or vehicle pools (neighboring users might have a stake in usage),
user spot (residential parking spot, non-residential parking destination, eg., work or school).

Pause is now taken to consider the phrase “(active) RFID readers.” In common usage it is an inclusive phrase which includes RFID devices of varying levels of sophistication. At a simple end of the spectrum, there are true “readers” only, which energize passive RFID tags with an electromagnetic-field at a defined frequency (ie., EMF), who in response to the designated signal (ie., the EMF) emits a radio signal containing a unique serial number. That is, not only does the RFID tag transforms the response signal to something which is not always counterpart to the interrogation signal (hence, transponder), but it also does so without a lot of intelligence on the transponder's side. At the other end of the spectrum there are RFID interrogators which engage in full two-way, transmission and reception communications with intelligent passive (or active) RFID miniatures.

Also, a telematic device is one generally involved in long-distance transmission of computerized information.

Moreover, a smartcard is generally an integrated circuit(s) card (ICC) that is any pocket-sized card with embedded integrated circuits. Although there is a diverse range of configurations, there are two broad categories of ICCs. Memory cards contain only non-volatile memory storage components, and perhaps some specific security logic. Microprocessor cards contain read/write memory and microprocessor components.

Whereas the term “smartcard” is used for convenience in this written description, it connotes the desire that the user's network interface be sized to slip in a man's or woman's wallet. However, as used in this written description, the term smartcards includes and does not exclude smart “(circuit) boards” or smart circuitry housed in other diminutive portable housings, such as and without limitation key or keychain fobs.

Briefly, a digression is taken to examine whether any structured classification of business-models for shared-use vehicle memberships has been, to date, satisfactorily concluded. With all due respect, such probably defies being anywhere concluded. However, structured classifications might begin with acknowledging the following factors:—namely,
links between dissimilar modes of travel
travel profiles of the user community (eg., all long-term or short-term use, in contrast to predominantly commuting (eg., uniform usage pattern) against non-commuting use (eg., random usage pattern), and mixtures thereof),
bundling with other services,
payment packages (eg., advance deposits, subscriptions, per-use, or mixes thereof)
auditing
security
fleet/system management
user convenience, especially with the interface, and then reservations, billing, flexibility in handling spontaneous travel plans (eg., short-notice demand response time/properties), and
geographic spread of network,

It is presumed that if a user departs on a trip way outside the geographic spread of the network, then that user is better served by shifting to the services of non-network providers of long-term vehicle rental (eg., U-Haul®).

Also, it is presumed that it the user flies into an out-of-network destination, then again that user's resources are preferably found with non-network providers of either short- or long-term rental (eg., Hertz®).

Further gradations of a structured classification would look at not only user-utilization profiles but vehicle-utilization profiles:—eg., whether the vehicle has a home node, none at all, or plural home nodes, and then whether the network topography is a line, a ring, a hub-and-spoke arrangement, a hub-spoke-and-ring arrangement, or a more distributed arrangement (sometimes graphically depicted as a star). Further complexities might account patterns such as the forward to reverse balance or imbalance of utilization, whether utilization is predominantly for return trips (eg., two-way travel), or otherwise cyclical or subject to patterns of travel. Other factors in the mix include whether the utilization is predominantly launched from a residence, or is work-based commuting from a mass transit station, or is episode-random utilization as by work-based day users or visitors, and so on.

In summary of the foregoing discussion, a structured classification of shared-use vehicle memberships can only be superficial because deeper analysis of user-community motives and fleet-management efficiencies make the complexity of such classification manifold.

To return to a more particularly and distinctly describing the invention, a smartcard system in accordance with the invention for transportation applications predominantly though not exclusively comprises, in review, the following preferred aspects:—

utilization for Parking, Rental, Bus, Taxi, and multiple parking applications,

utilization for managing fractional leases,

utilization for auto insurance data & coverage preferences, and

utilization for driver-specific vehicle settings & preferences.

Utilization No. 1.—Multi-function Smartcard for Parking, Transit, and Car-Sharing use.

This utilization is for a dual-interface (contact and contactless) “smartcard” which supports the following (transportation-related) functions:
1. User ID
2. Stored Value (“e-purse”)
3. Transit or Taxicab Fare
   a. Bus, rail, taxi, or water vessel fare (single or multi-token)
   b. Bus, rail, taxi, or water vessel fare (daily/weekly/monthly pass)
   c. Bus, rail, taxi, or water vessel fare (fixed price)
4. Parking
   a. Gated Parking Lot Entry/Exit
   b. Single-space Parking Meter
   c. Multi-space Parking Meter
   d. In-vehicle (dashboard or rear-view mirror-mounted) Parking meter
5. Car Sharing or Rental Car Membership/Loyalty
6. Merchant Membership/Loyalty
   The Problem:

In today's cities, more and more transportation services cost money, but existing forms of payment impose burdens on both users and service providers. Whether the service is on-street parallel parking, commuter rail fare, or taxicab fare, both users and service providers struggle with bulky and inconvenient cash payment or time-consuming and expensive credit- or debit-card payments.

The Solution:

The disclosed device reduces the inconvenience of transportation-related service payments through the use of a dual-interface, multi-function smartcard. The card uses a contact interface for high-security transactions (such as adding value to the card) and in order to maintain compatibility with existing contact-only card reader devices. At the same time, the card contains a contactless interface for ease of use, for example, when paying bus, rail, or taxicab fares.

For the user, the card eliminates the need to carry bulky, inconvenient change for parking meters, and allows payment of exact fares for transit services without carrying cash at all. The card is more convenient than existing smartcards because it (1) supports multiple types of parking device (single-space, multi-space, in-vehicle) from multiple vendors, and (2) supports multiple services (parking, transit, taxicab, and car sharing or car rental) within a single card.

For the service provider, the card eliminates the need to collect cash from parking meters or fareboxes, lowering collection costs and security risks. The card also allows the collection of more detailed usage data than cash-based devices, and allows the introduction of customized fares (for students, seniors, time-based passes, or special events) without the need for special farebox hardware or operator intervention. The cards also lower maintenance costs when the contactless interface is used, since neither the reader nor the card have moving parts that wear, corrode, or jam.

For car sharing or car rental, the card serves to identify the user and the services for which the user qualifies. It can also identify the reservation status of the user (in particular, whether the user has “checked out” a vehicle). The card is superior to systems in use in the US today in that (1) the card has a greater degree of security than “Serial number only” cards, and (2) the card is multi-functional; the same can be used for transit and parking as well as car sharing. The card also has more memory available for user preferences and account settings than cards in use today.

Because the card has significant memory, space is available for merchant loyalty applications as well, in which card users can earn “points” when they make purchases from participating merchants. The points can then be redeemed for free or discounted merchandise or services.

The card supports encryption appropriate for the value of the transactions in question, and applications have unique keys so that one application cannot access data intended for another application without permission.

System Elements:

The system comprises:
1. a dual-interface smartcard,
2. a method for adding personal information to the card,
3. a method for adding value to the card,
4. card readers in the taxicab or transit vehicle which read the cards and deduct the appropriate fare,
5. card readers at or near parking lots which read the cards and authorize entry or exit and deduct a fee if appropriate,
6. on-board computers in shared or rental vehicles which read the cards, grant access, and enable use of the vehicles based on reservations or other specified criteria,
7. card readers at merchant locations which deduct value from the cards based on purchases and add merchant loyalty “points” to the card based on specified criteria, and
8. a central system which manages user information, schedules usage of shared or rental vehicles, and reconciles transactions between merchants or service providers and card users.
   Utilization #2—Smartcard to Manage Fractional Lease.

This utilization is for a contactless or dual-interface smartcard used to control access to a vehicle with multiple authorized users (either rental or fractional lease).

The Problem:

For decades, if not longer, vehicles have been shared in order to make efficient use of an expensive capital good and to lower the cost of use to vehicle users. Methods of controlling access to the vehicles and allocating cost have been as simple as unwritten agreements between roommates. For most vehicles, though, controlling access to a vehicle with multiple authorized users has been a complex problem with only cumbersome and costly solutions, which has severely restricted the market for fractionally leased vehicles.

The Solution:

The invention simplifies access to vehicles with multiple authorized users by creating smartcard “keys” which securely identify the user and providing an intelligent lock in the vehicle which can selectively open or enable use of the vehicle based on time of day, pre-existing reservation, presence of an access “token”, or other access criteria.

System Elements:

The system comprises:
1. A smartcard which contains account information for a single individual,
2. on-board computers in vehicles which read the smartcards, provide access to the vehicles, and enable their use based on time of day, pre-existing reservation, presence of an access “token”, or other access criteria,
3. “On-site” readers which read the smartcards and provide access to vehicle keys based on time of day, pre-existing reservation, presence of an access “token”, or other access criteria,
4. a central system which manages user information, schedules usage of vehicles, and reconciles transactions for customer billing purposes.
   Utilization #3—Smartcard for Auto Insurance Information.

This utilization is for a smartcard used to manage automobile insurance information.

The Problem:

Many drivers do not know enough about their automobile insurance coverage to select the appropriate coverage when renting automobiles. As a result, drivers either purchase insurance or other services which are not necessary, or they drive without insurance coverage which they want (and may erroneously believe that they have).

The Solution:

The invention consists of a smartcard which contains both detailed customer automobile insurance information and information about customer coverage preferences. The customer presents the card when renting an automobile, and the rental agent provides rental insurance based on the customer's predefined preferences.

Utilization #4—Smartcard for Driver-Specific Automobile Settings and Preferences.

This utilization is for a smartcard used to manage driver-specific automobile settings and preference information.

The Problem:

Many drivers share vehicles with other drivers. Whenever a new driver accesses a shared vehicle, they must adjust various parts of the car, such as seats and mirrors, to fit their personal preferences. While some vehicle manufacturers accommodate more than one driver by storing driver information in the vehicle and identifying drivers by their key or remote access device, their systems typically support a very limited number of drivers (often, only two).

The Solution:

The invention comprises a smartcard which contains driver-specific automobile settings and preferences, including:
1. Seat adjustment for electronically-adjustable seats
2. Rear-view mirror adjustment settings
3. Entertainment preferences (Radio station pre-sets, balance/fade and treble/bass settings)
4. Performance preferences (“sport”, “economy”, etc.)
5. Climate Control preferences (temperature and vent settings)
6. Display preferences (“MPH” vs. “KM/H”, ° F. vs. ° C., etc.)
7. Traffic Information preferences (Receive all alerts, major alerts only, etc.).

In addition, a card reader in the vehicle which reads the relevant driver preferences and communicates those preferences to the relevant devices in the vehicle.

The card IC can be contained in a variety of form factors, including standard “credit card” form, key fob, or integrated into another device such as a remote access/keyless entry device.

Since the driver preferences are stored on the driver's smartcard, the vehicle can accommodate an unlimited number of drivers while still adjusting to the individual preferences of the driver.

It is preferred to configure the inventive network smart device (card) with:—
one or more passive (or semi-active, or passive) RFID circuits for contactless RFID transmission/reception,
microprocessor, for executing high-level functions such as
   two-way communications,
   high-level communications security,
   data integrity functions, as well as
   data-polling and -propagation,
   acting on system instructions that certain data has been uploaded and hence that memory space is freed up
read/write memory for data including
   executable code data,
   user identity,
   reservation data (eg., for a shared vehicle),
   financial data (eg., for paying a fare on public/private mass transit)
   user preferences,
   user-identity authentication (eg., biometrics information, eg., fingerprint)
   storing polled data such as transfer entitlements or loyalty purchases, and then propagating that to system readers,
   supervision between reader and smartcard (eg., another five minutes has passed and this smartcard has accepted the reader's supervision communication, as well as any data sent therewith, including updated public decryption key and so on)
   GPS data, so that polled-and-transferred data such as mileage also includes GPS position.

It is preferred to configure the inventive vehicle-mounted telematic device with:
a wireless modem (eg., a cellular, Wi-FiO or satellite link),
CPU, plus read/write memory,
active RFID transmission/reception circuitry,
user PIN-code entry interface,
biometric entry-interfaces or readers,
interfaces with CANBUS or OBD II buses to monitor vehicle sensor data,
interfaces with custom sensors (eg., for mileage),
(optionally) speaker phone, and
(very optionally, subject to users sensitivity to privacy) a webcam or the like.

Wi-Fi® is a trademark for sets of compatibility standards for wireless local area networks (WLANs). Wi-Fi is intended to allow mobile devices, such as laptop computers and personal digital assistants (PDAs) to connect to local area networks, but is now often used for Internet access and wireless VoIP phones. Desktop computers can also use Wi-Fi, allowing offices and homes to be networked without expensive wiring.

OBD II stands for Updated On-Board Diagnostics (code bus), which is a standard effective in cars sold in the U.S. after Jan. 1, 1996. CANBUS (also referred to as CANbus or CAN bus) is a network used in many every-day products consisting of multiple microcontrollers that need to communicate with each other. It is nowadays mandated for cars sold in the U.S., first having been accepted by European car manufacturers.

The security of the preferred embodiments of the invention is based on a public key infrastructure (PKI), where each device involved has a public encryption key and a digital signature key stored in a public key repository such as an X.500 directory or a public key database. These keys are certified by a Certification Authority (CA).

A smartcard used to access a telematic device first sends the telematic device an encrypted message comprising the smartcard's digital signature.

On receipt of the message, the telematic device decrypts the message with the smartcard's public decryption key, onfile with and obtained from the central authority, to verify the smartcard's digital signature. Failure to verify results in an error message being returned to the central authority and displayed on a display device viewable through the windshield to the user wielding the smartcard. If the signature verifies, the telematic device sends the smartcard an encrypted message containing its digital signature. The smartcard decrypts the message with the telematic device's public decryption key, which is pre-stored on the smartcard, and attempts to verify the sent digital signature. If it verifies, then the smartcard sends a request for vehicle access. The telematic device checks its records for a reservation for that smartcard, and if there is one, the telematic device unlocks the door to the vehicle and registers the beginning of this transaction by generating a transaction log which it sends or will send to the central authority.

### EXAMPLE 1

To reserve a vehicle, a user goes online by any suitable means, including by wireless devices and connections such as laptop computers, utilizing Wi-Fi, or PDA's and so on. The user utilizes an online resource of the central network authority to request a reservation for use of a vehicle at a selected node at a selected time, and preferably also specifying the estimated drop off place and time. In this example, the reservation is granted. The online resource serves the user online notice of the reservation being granted. In this example, the user is also served the message that such user is reserved a certain, specific vehicle.

The central network authority shall supply the telematic device of that certain, specific vehicle the information needed to admit the user to drive off with the vehicle. The central network authority can either propagate that information in advance (eg., push the data) or wait until polled by the telematic device (eg., the data is pulled). Presumably, the information sent to the telematic device includes not only information about the reservation but also information that might be needed to carry out secure communications and then thereafter verify that the correct user is authorized to drive off with the car. Accordingly, such sent information might comprise:

the smartcard's serial number,

the smartcard's public decryption key,

the smartcard's digital signature,

reservation information,

user biometric information, and so on.

For the user to enter the vehicle, the vehicle's telematic device has to be satisfied of a two or three level authentication process. First, the telematic device has to satisfy itself it is communicating with the correct smartcard. The user should hold up the smartcard close to the active RFID antenna of the telematic device. Preferably this is located behind the windshield on the driver side. At least satisfying the telematic device by this first step has the telematic device unlocking the driver side door, so that the user can enter the car. Then, the user might be required to enter a PIN number or the like on a keypad or like manual interface. Also, the user might be required to submit to a biometrics test, such as affording a fingerprint reader to take a scan of the user's fingerprint. Presumably, the biometric device has the fingerprint information stored onboard and is programmed to make a determination of authenticity or not.

The steps of PIN entry and biometrics testing may not only be used together but might also just be used as alternates to each other, wherein some telematic devices just require PIN codes while others require biometric testing.

Whichever way the telematic device works to satisfy itself the correct user is requesting to drive the car, the telematic device facilitates this. The foregoing might be achieved without limitation by fixing an ignition key in the steering column but locking it until the telematic device generates an unlocking signal. That way, the ignition key is unlocked for twisting, and the user can start up the vehicle, and drive away.

The telematic device's active RFID circuit is presumptively'strong enough to raise a response from the user's smartcard as long as it is located within the passenger compartment or trunk of the vehicle. That way, the telematic device can periodically send a test message to the smartcard to raise merely a check-in response. The information that both, one, the vehicle engine has not been shut off since the biometrics test was undertaken to start it and, two, the smartcard is no longer riding with the vehicle but is remote if not out of range can be utilized for various purposes. One example purpose might be, and without limitation, for the purpose of evaluating whether a car-jacking is taking place. In this scenario, both the speaker phone and webcam options of the telematic device might help the central network authority not only save the vehicle but the user as well.

Each time the user shuts the engine off, the activity of restarting the engine will require a repeat of some or all of the previously-described authentication steps. Preferably the user and central network authority are in agreement whether the user is releasing the vehicle or not each time the user shuts the engine off. That way, for temporary stops, the user does not unknowingly lose the vehicle to a successive reservation. This agreement might be accomplished in any of the following ways, and without limitation. The user might be expected to transmit through the telematic device a positive message each time the vehicle is shut off indication continued retention or release. Alternatively, the user might be expected to transmit positive indications of retention, wherein release is inferred by the absence of such. Or the user might be expected to transmit positive indications of release, wherein retention is inferred by the absence of such. Otherwise, whether a user is retaining or releasing the vehicle after each engine shut off might be reckoned from other circumstances, such as if the user's stop is a known intermediate destination in the trip itinerary known to the central network authority, or if the user's stop is the known end-destination, and so on.

When the user has completed his or her utilization of the vehicle, preferably he or she drops it off a network-approved spot, perhaps the same general location where picked up or perhaps a remote other place.

The telematic device continually logs the user's utilization of the vehicle. Preferably the telematic device polls the vehicle for mileage and fuel usage. The telematic device either transmits the transaction record at the completion of a user's utilization, or else feeds the central network authority a series of update reports.

### EXAMPLE 2

This example is comparable to the previous example except the biometric testing is implemented in a distinctively different way. That is, the user is among the few nowadays who has a miniature RFID tag implanted in him or herself. The vehicle's telematic device is supplied by the central network authority the information needed to raise a response from the implanted RFID tag and then also certify it is authentically associated with the identity of that user. The telematic device is configured such that the active RFID circuit capable of transmission and reception with the smartcard RFID circuit is also capable of reading the implanted RFID tag, or else the telematic device is configured with an auxiliary RFID reader specially for the purpose of reading the implanted RFID tag.

Accordingly, the telematic device is satisfied to allow the user to take possession of the vehicle when both conditions are true that, one, the smartcard is authenticated and, two, the implanted RFID tag is authenticated.

### EXAMPLE 3

This example bears resemblance to Example 1. The description that follows compares and contrasts various ways resembles or differs from Example 1. A user contacts the online resource of the central network authority to request a reservation the same way, for a trip departing from a network node at the user's selected time.

However, instead of being granted a reservation to one specific vehicle, the user is granted a reservation to a class of cars. Perhaps in the user's request the user specifies that he or she desires a four-door sedan, or else any vehicle of automaker brand “X,” or even more specifically any coupe to four-door sedan of automaker brand “X.” The online resource allows the user to survey the then-available cars at the specified node, and provide a history of what makes and models are typically available on-demand. Hence the user seeks not a guaranteed reservation to a specific vehicle but is more flexibly willing to accept a reservation to a class of vehicles. The user can define the class quite narrowly, or depending on the urgency over need for a vehicle and willingness to accept what is available the user might allow a range of vehicles to be encompassed in the class. The online resource even affords the user the opportunity to rank preferences in priority sub-classes.

In this example, rather than furnishing each vehicle with a telematic device, the parking lot of the network node as a whole is serviced by a single dispensing kiosk furnished with a communications link to the central network authority. That is, the dispensing kiosk dispenses the user a vehicle-access pass to a specific vehicle, optimizing the match between what is available and the user's preferences. The vehicle-access pass can be any of a key, a fob (with or without RFID functionality of IC processing), or a card (again, with or without RFID functionality of IC processing), and so on.

The dispensing kiosk tasks through the work of authenticating the user by smartcard, PIN code, biometrics matching and so on. Hence this relieves furnishing each vehicle with such processing and interfacing capability. That way, the network fleet of shared vehicles each are equipped with less costly equipment than in Example 1.

Nevertheless, it is advantageous to provide the shared vehicles with telematic devices after all, for undertaking security measures during a user's retention of the vehicle and then transmitting a record of the trip, periodically or at the end, to the central network authority.

It is an aspect of the invention that the network smartcard in accordance with the invention has processing, read/write memory, and RFID transmission/reception capability (in contrast to mere RFID transponder). That way, a network RFID transmission/reception device can write data on the network smartcard. This is advantageous for various distinctive reasons. Three such reasons are described next as non-limiting examples of other such reasons.

One, for PKI security, the network smartcard will have to be able to retrieve from on-card memory the public decryption key of network RFID interrogators. One way for the central network authority to ensure network smartcards all have the proper public decryption key of any network RFID interrogator is to define a universal public decryption key which works for all network RFID interrogators. However, as time extends, the central network authority may decide to change the universal public decryption key. Doing so with the network RFID interrogators is readily accomplished as all are readily transmitted notice of such change either through attached telematic interfaces or land lines and the like. Conversely, the network smartcards will all have to be updated on a gradual basis as, for example, each exchanges transmissions with a network RFID interrogator. Contrast user A to user B. User A uses a network shared vehicle on a daily basis. Within a day or over a weekend, a network RFID interrogator is both able to accept secure transmissions with user A's network smartcard with the outdated universal public decryption key while taking that opportunity to upload onto user A's network smartcard the updated universal public decryption key. And so on, except user B is much less frequent user of network shared vehicles. User B might not utilize his or her network smartcard for days or weeks after the change. Network RFID interrogators may accept secure communications on the basis of an outdated universal public decryption key for some extended grace period. The network RFID interrogators might even be programmed to contact the central network authority to do so. But after some cutoff period, user B's network smartcard is stale. Hence user B faces the possibility of renewing his or her account with the network authority through some means which will authorize the uploading of the up-to-date universal public decryption key.

Two, consider the matter of conditional transfers onto non-network transit affiliates. These are parties with non-network RFID readers. This might be more simply understood by an example. A user desires to take a trip to a destination such that if the user utilizes a network shared-use vehicle to get only part way to the destination, but elects to hop onto public mass transit to complete the trip, the user shall have to transfer onto the public mass transit. The central network authority might confer onto that user by a software token stored on the user's network smartcard a transfer pass. Thus, if the user indeed utilizes the network shared-use vehicle to complete a first segment of the trip, then the vehicle's telematic device might download a software token which will allow the user to board the public mass transit. As the user continues on his or her trip, the user advances toward boarding a subway that accepts RFID-supplied software tokens. However, the subway system's RFID readers are not networked to the central network authority for the smartcard system in accordance with the invention. Hence the subway system cannot or will not attempt to query the communications resources of the central network authority to confirm the validity or not of the software token. Even if such electronic inquiry and response could be carried out in three seconds, that lapse of time is too slow to move subway passengers through turnstiles. The user's network smartcard needs to carry the software token on-card without having to tell the non-networked RFID reader of the subway to “fetch it from my central network authority” or the like. Hence it is advantageous that so long as the user's network smartcard is within proximity to a networked telematic device, the central network authority can upload temporary software tokens to non-networked transit associates.

Three, consider foregoing item two in reverse, wherein the user utilizes his or her card to purchase goods or services from a non-networked loyalty associate with the e-purse on the card. That is, the user will earn rewards if he or she consistently purchases coffee at coffee vendor “S.” Wherein the active RFID readers of coffee vendor “S” are capable of processing a credit payment of the e-purse on the networked smartcard, the central network authority may have no way of verifying the loyalty purchase until the user afterwards utilizes the network smartcard with a network RFID interrogator. Hence, it is advantageous for the network smartcard to log such purchases from non-network loyalty affiliates until such time as the log of such purchases can be uploaded to the central network authority by means of one of its own transmission and reception communicators.

It is an aspect of the invention that users can pay for non-networked parking lot charges with the network smartcard.

It is a preference of the invention that the telematic devices, among other network RFID interrogators, operate on the 13.56 MHz band (ie., high frequency, in contrast to low, ultra-high and microwave frequencies). In the spectrum from lowest to highest frequencies, low frequencies require closer proximity between active reader and passive transceiver to work sufficiently, but conversely lower frequencies are less attenuated by metallic films such as are common on windshields nowadays.

It is furthermore a preference of the invention that onboard telematic devices (eg., mounted on network shared-use vehicles underneath the windshield) can go to sleep until manually actuated to wake up. One way to accomplish this is to provide a capacitance switch on the exterior of the vehicle which the user must touch before the user can expect the onboard telematic device to start interrogating his or her network smartcard. This is preferred because it saves the vehicle battery from draining of power while the telematic device continually samples the atmosphere for the correct network smartcard, which may be days or hours away from arrival.

It is an aspect of the invention that the network smartcard does not actually serve the vehicle telematic device the reservation. Conversely, the central network authority supplies the vehicle's telematic device with the reservation information. That way, users make reservations online with the central network authority. Users do not have to be proximate an active RFID transmission and reception device which uploads the reservation information onto their network card. The network information is passed from the central network authority to wherever it is that users pick-up their reserved information. Thus users can make reservations by nothing else than an online connection, and do not have to have RFID writers or printers writing or printing that information onto their network smartcards.

It is a further aspect of the invention to network-in private mass transit. Briefly, the terminology here involves distinguishing between private and public mass transit. U.S. air carriers are examples of private mass transit. Urban commuter trains are believed to be almost uniformly public mass transit. Buses span over onto both forms. Local bus networks are believed to be almost uniformly public mass transit. Conversely, the inter-city line Greyhound® is an example of private mass transit.

The foregoing are actual examples of what are and are not private mass transit. That aside, perception is far different. Air travel is not widely viewed as mass transit. It is supposed is a group of business travelers were asked if they traveled on any mass transit within the preceding year, most would not count air travel as an instance of mass transit.

The perceived distinction by business travelers presumably resides in comfort to do work while letting someone else to the driving. That is, the comfort to pull-out laptops or briefcases of paperwork and absorb oneself into work. In consequence, it is an aspect of the invention to incorporate networked-in ground transit specifically designed with the comfort of the business traveler in mind. This is achieved by providing network shuttles, even network buses, that are wirelessly linked to communications networks so that travelers can link up through wireless online devices to the global communications network (eg., the Internet®) as by cellular networks or Wi-Fi connections and so on. And so, it is an aspect of the invention to provide business-class ground mass transit, whether as a loss-leader or at a premium, in order to get more users to utilize the network fleet of shared-use vehicles.

In summary, the multi-application networked smartcard in accordance with the invention transportation applications includes without limitation the following aspects. That is, such utilities provided by the network smartcard will comprise:
1. Stored Value (“e-purse”)
2. Shuttle Bus (single token)
3. Shuttle Bus (monthly pass)
4. Rental Car Membership/Loyalty
5. Gated Parking Lot Entry/Exit
6. Single-space Parking Meter
7. Multi-space Parking Meter
8. Merchant Membership/Loyalty
9. Other applications likely to support both contact (ISO 7816) and contactless (ISO 14443A/B) interfaces. (The JavaCard O/S is a leading candidate.)

Robust data encryption (DES, RSA PKI or the like) will likely be supported or not according to balancing costs against benefits. This includes without limitation the Philips® Mifare® standard.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A smart card system for transportation services, comprising:
a dual-interface smart card,
a computer-implemented adder of personal information to the card,
a computer-implemented adder of value to the card,
a plurality of card readers for the taxicab or transit vehicle which read the cards and deduct the appropriate fare,
another plurality of card readers at or near parking lots which read the cards and authorize entry or exit and deduct a fee if appropriate,
on-board computers in shared or rental vehicles which read the cards, grant access, and enable use of the vehicles based on reservations or other specified criteria,
a further plurality of card readers at merchant locations which deduct value from the cards based on purchases and add merchant loyalty “points” to the card based on specified criteria, and
a central system which manages user information, schedules usage of shared or rental vehicles, and reconciles transactions between merchants or service providers and card users.
